(19) United States
(12) Patent Application Publication
(10) Pub. No.: US 2026/0008179 A1
(43) Pub. Date: Jan. 8, 2026

(54) STIFFNESS ENHANCING MECHANISM FOR ROBOT AND WORKING METHOD THEREOF

(71) Applicant: Shandong University, Jinan (CN)

(72) Inventors: Kai Guo, Jinan (CN); Zhenhua Dou, Jinan (CN); Jie Sun, Jinan (CN); Xiaoming Huang, Jinan (CN); Yixiang Liu, Jinan (CN)

(73) Assignee: Shandong University, Jinan, SD (CN)

(21) Appl. No.: 19/328,100

(22) Filed: Sep. 12, 2025

(30) Foreign Application Priority Data
Mar. 11, 2025 (CN) 202510280288.0

(51) Int. Cl. B25J 9/16

(52) U.S. Cl. CPC B25J 9/1653

(57) ABSTRACT

Stiffness enhancing mechanism for a robot and working method thereof are disclosed. The stiffness enhancing mechanism comprises a base bracket arranged at a first joint of a robot, the base bracket supports a damper member. A two-shaft joint damping disk is arranged at a second joint of the robot, and a pulley block is arranged at the two-shaft joint damping disk. A main-arm bracket is arranged at a second-linkage main arm of the robot, and an auxiliary-arm bracket is arranged at a parallel-linkage auxiliary arm of the robot. A damping cable is connected to the main-arm bracket and the auxiliary-arm bracket and wound at the damper member, and wound around a pulley block at the two-shaft joint damping disk after passing through a tension device, to change a torque direction of the damping cable via the pulley block. The damping cable provides a damping torque to the robot.

### CROSS-REFERENCE TO RELATED APPLICATION

This application claims priority to Chinese Patent Application No. 202510280288.0, filed on Mar. 11, 2025, which is hereby incorporated by reference in its entirety.

### TECHNICAL FIELD

The present disclosure relates to the technical field of robot, particularly to stiffness enhancing mechanism for a robot and working method thereof.

### BACKGROUND ART

The statements in this section only provide background technical information related to the present disclosure and do not necessarily constitute prior art.

Industrial robots, with their characteristics of large reachable space, high dexterity, compact size, and multi-functionality, are widely used in multiple fields, promoting the transformation of traditional industries from labor-intensive to technology-intensive, and enhancing the overall level and competitiveness of high-end manufacturing. However, industrial robots are typical open-chain and multi-rod series structures, which are affected by coupling of transmission mechanisms, joint deformation, friction, environment, and other factors. When high-strength workpieces are processed, robot resonance is easily induced, resulting in mid to low frequency flutters. And stiffness of the robots has a characteristic of non-linear distribution throughout the entire workspace. The external forces experienced by the robot during a machining process can cause irregular deviations, thereby affecting the surface quality and machining accuracy of the workpiece. Researchers have shown that robot positioning errors caused by geometric factor and stiffness factor of the robot account for over 90% of all positioning errors, severely limiting the application of industrial robots in high-precision machining processes.

At present, the commonly used method is offline optimization of process parameters for flutters in machining process, which has poor universality of working conditions. Moreover, the method is suppressed to be limited by the weak stiffness characteristics of the robot itself, and cannot accurately compensate for the elastic deformation motion of the joint of the mechanical arm during rigidly rotating. There are still problems such as multi-variable input, strong non-linearity, and severe coupling of dynamic characteristics.

The main source of flutter of structures in robot is the inability to adjust radial and axial gaps during a joint driving process, resulting in joint flexibility and weak stiffness in the terminal machining trajectory. The existing method for suppressing flutter of industrial robot mainly attaches a flutter-suppression device to an end actuator, and semi-active and passive flutter-suppression methods introduce machining-vibration energy into additional transposes for dissipation, thereby improving dynamic stiffness of robot's machining trajectories. However, the machining stiffness of robot is related to a pose height, and an end dynamic stiffness in a part machining process has spatial time-varying characteristics. In addition, an end flutter-suppression device introduces additional rotational inertia, which affects environmental adaptability and dynamic response of the robot, resulting in redundant and wasteful joint output torque, and has certain applicability limitations.

### SUMMARY

The purpose of the present disclosure is to provide a stiffness enhancing mechanism for a robot, which utilizes damper members to dissipate flutter energy during a robot machining processes and optimizes stiffness of system structures, in response to the shortcomings of existing technologies.

In order to achieve the above objectives, the present disclosure is implemented through the following technical solution.

A stiffness enhancing mechanism for a robot is provided, which includes a base bracket arranged at a first joint of the robot, the base bracket supports a damper member, a two-shaft joint damping disk is arranged at a second joint of the robot, a pulley block is arranged at the two-shaft joint damping disk, a main-arm bracket is arranged at a second-linkage main arm of the robot, an auxiliary-arm bracket is arranged at a parallel-linkage auxiliary arm, a damping cable is connected to the main-arm bracket and the auxiliary-arm bracket and is wound at the damper member and then is passed through a tension device and is wound around the pulley block at the two-shaft joint damping disk to change a torque direction of the damping cable via the pulley block, the damping cable provides a damping torque to the robot.

The aforementioned stiffness enhancing mechanism for a robot further includes: a first pulley and a second pulley. The first pulley is arranged at a hinge position between the parallel-linkage auxiliary arm and the second-linkage main arm. The second pulley is arranged below the two-shaft joint damping disk. The damping cable is wound around the first pulley and the second pulley to change a direction of the damping cable via the first pulley and the second pulley.

In the aforementioned stiffness enhancing mechanism for a robot, the damping cable includes two sections. A first-section damping cable passes through the main-arm bracket, the auxiliary-arm bracket, and the first pulley in sequence, and the second-section damping cable passes through the pulley block, the second pulley, the tension device, and the damper member in sequence. The first-section damping cable is connected to the second-section damping cable via pulling-force sensors to form a closed cable assembly.

In the aforementioned stiffness enhancing mechanism for a robot, the two-shaft joint damping disk includes a pulley-block basement. The pulley-block basement is connected to a coaxial line of the second joint, and the pulley-block basement supports the pulley block. The pulley block includes third pulleys and fourth pulleys. Multiple third pulleys and at least two fourth pulleys are arranged. The multiple third pulleys are arranged along a circumferential direction of the pulley-block basement, and all the fourth pulleys are arranged inside an area of connection of adjacent two third pulleys of all the third pulleys. One side of the pulley-block basement is protruded, and a guide pulley is arranged at a protruded position of the pulley-block basement. The damping cable passes through a portion of the third pulleys, the fourth pulleys, an other portion of the third pulleys, and the guide pulley in sequence, so that a direction of a section of the damping cable located between the guide pulley and the main-arm bracket and a direction of the second-linkage main arm are same.

In the aforementioned stiffness enhancing mechanism for a robot, a stop component is also arranged at the protruded position of the pulley-block basement. The stop component is connected to a pulley shaft of the guide pulley and the protruded position of the pulley-block basement, so that an interval distance is arranged between the stop component and the guide pulley to limit position of the damping cable.

In the aforementioned stiffness enhancing mechanism for a robot, at least two main-arm brackets are arranged, and the main-arm brackets are arranged at a circumferential direction of the second-linkage main arm. A hanging bolt is installed at side of the main-arm bracket, and the damping cable passes through the hanging bolt of the main-arm bracket. The hanging bolt is installed at the main-arm bracket via a main-arm hanging fixing.

At least one auxiliary-arm bracket is arranged. The auxiliary-arm bracket is arranged with the main-arm bracket in a staggered manner. The auxiliary-arm bracket is fixed at a circumferential direction of the parallel-linkage auxiliary arm. The hanging bolt is installed at side of the auxiliary-arm bracket. The damping cable passes through the hanging bolt at the auxiliary-arm bracket, and the hanging bolt is installed at the auxiliary-arm bracket via the auxiliary-arm hanging fixing.

A structure of the main-arm hanging fixing and a structure of the auxiliary-arm hanging fixing are same, each of which includes a convex cavity. A second nut is arranged inside the convex nut, and a third nut is arranged outside the convex cavity. The hanging bolt passes through the third nut and the second nut in sequence.

In the aforementioned stiffness enhancing mechanism for a robot, an adaptive tighten claw is arranged at side of the main-arm bracket. The adaptive tighten claw includes an adjustment bolt, the adjustment bolt passes through a welding nut and the side of the main-arm bracket, the welding nut is fixed at the side of the main-arm bracket. An end of the adjustment bolt is connected to a fastening hinge point, the fastening hinge point is hinged and connected to a sheet for tighten claw, and the sheet for tighten claw can rotate along the fastening hinge point to adapt to the second-linkage main arm.

In the aforementioned stiffness enhancing mechanism for a robot, the damper member includes two sliding damping assemblies. A tension pulley is arranged between the two sliding damping assemblies. The damping cable winds around the tension pulley. Each of the two sliding damping assemblies includes two dampers arranged opposite to each other. An extendable end of each of the two dampers is connected to a damper central block. A damper central rod passes through the damper central block. One end of the damper central rod that passes through the damper central block is connected to the base bracket, and an other end of the damper central rod passes through a damper position-limiting block. Each of two sides of the damper central rod that located at the damper central block is sheathed with tension springs. A fixed end of the damper is connected to the base bracket via a connecting rod, and the fixed end of the damper is connected to the damper position-limiting block via a connecting rod.

In the aforementioned stiffness enhancing mechanism for a robot, the tension device includes a tension bracket. The tension bracket is installed at the base bracket. A position of the tension bracket relative to the base bracket can be adjusted. The tension bracket supports a tension adjustment assembly and a tension clamping assembly. The tension adjustment assembly includes a movement component, which can slidely installed at the tension bracket. The movement component is connected to a cylinder clasping shaft. A fifth pulley is arranged at one end of the cylinder clasping shaft away from the movement component. The damping cable winds around the fifth pulley to adjust a tension degree of the damping cable via the movement component. One side of the fifth pulley is provided with a stop component.

In the aforementioned stiffness enhancing mechanism for a robot, the tension clamping assembly clamps the cylinder clasping shaft, and can lock the cylinder clasping shaft. The fifth pulley is arranged below the damper member, and the cylinder clasping shaft is inclined upwards relative to bottom of the base bracket.

In the aforementioned stiffness enhancing mechanism for a robot, the base bracket includes a pedestal frame. The pedestal frame supports a vertical frame, and the vertical frame supports a fixing plate. The fixing plate is provided with multiple layers of installation holes, and installation holes of adjacent two layers of installation holes are arranged in a staggered manner. The damper member is installed at the fixing plate via the installation holes.

According to the second aspect, a working method for the stiffness enhancing mechanism for a robot is also provided by the present disclosure. The working method includes following steps.

A base bracket is arranged at the first joint of the robot, and the base bracket supports the damper member. The two-shaft joint damping disk is arranged at the second joint, and the pulley block is arranged at the two-shaft joint damping disk. The main-arm bracket is arranged at the second-linkage main arm, and the auxiliary-arm bracket is arranged at the parallel-linkage auxiliary arm.

The damping cable is connected to the main-arm bracket and the auxiliary-arm bracket and wound at the damper member, and then passes through the tension device and wound around the pulley block at the two-shaft joint damping disk.

The robot is in a zero position posture. The damper member provides an interval damping force to the damper cable. The tension device is contacted to the damping cable according to actual needs to deform the damping cable to provide an initial tension force.

During working processes of the first arm, the second-linkage main arm, the parallel-linkage auxiliary arm, and the third arm of the robot, the damping cable introduces a damping torque to the second joint, the second-linkage main arm, and the parallel-linkage auxiliary arm, to achieve dissipation of flutter energy of joint structures.

The beneficial effects of the present disclosure are as follows.
1) The present disclosure addresses the problems of weak structural stiffness and severe dynamic coupling in industrial robot. The damping cable is connected to the second-linkage main arm, the third joint, and the parallel-linkage auxiliary arm to provide damping via the damper member, so that a damping torque can be introduced into the second joint, the third joint, and the second-linkage main arm of the robot via the damping cable, to achieve efficient dissipation of flutter energy of the joint structures, enhancing machining stability and accuracy of the robot. And the stiffness enhancing mechanism is designed to fit the structure of the industrial robot, without interfering with its original degrees of freedom and workspace, ensuring that the robot meets the requirements of complex work tasks, has high adaptability and compatibility, and thus improves the machining accuracy of the industrial robot without sacrificing robot's environmental adaptability and dynamic response characteristics.
2) The present disclosure can adjust the pulling-force experienced by the damping cable to an appropriate range according to the inherent modal of the robot joint, ensuring a modal matching state between the robot and the stiffness enhancing mechanism, thereby inducing the vibration generated by the joint during a robot machining process to the damping cable, thereby reducing the modal frequency of the robot joint. And the sliding damping component can automatically adjust the motion range of the damping cable according to the motion state of the mechanical arm during the machining process, and effectively apply stable damping force to the damping cable, so that the robot with the stiffness enhancing mechanism can maintain the continuity and stability of the interval damping force in various machining conditions.
3) The structure of the pulley block in the present disclosure is reasonable, and the pulley block includes third pulleys and fourth pulleys. All the third pulleys are arranged outside an area enclosed by connection of adjacent two fourth pulleys of all the fourth pulleys, so that the damping cable can wind around a portion of the third pulleys, the fourth pulleys, and an other portion of the third pulleys in sequence to change a direction of the damping cable via the guide pulley.
4) In the present disclosure, the structure of the main-arm bracket and the auxiliary-arm bracket is reasonable, and each of the main-arm bracket and the auxiliary-arm bracket is matched with the second-linkage main arm and the parallel-linkage auxiliary arm of the robot to ensure stable setting. Adaptive tighten claws are arranged at the main-arm bracket to effectively fit with the second-linkage main arm. The main-arm bracket supports a hanging bolt via the main-arm hanging fixing, and the auxiliary-arm bracket supports a hanging bolt via the auxiliary-arm hanging fixing, ensuring the stable setting of the hanging bolts and preventing the hanging bolts from moving due to the traction force of the damping cable.

### BRIEF DESCRIPTION OF THE DRAWINGS

The accompanying drawings, which constitute a part of the present disclosure, are used to provide further understanding of the present disclosure. The illustrative embodiments and their descriptions of the present disclosure are used to explain the present disclosure and do not constitute undue limitation of the present disclosure.

FIG. 1 is an assembly diagram of a robot with a stiffness enhancing mechanism according to one or more embodiments of the present disclosure.

FIG. 2 is an exploded view of a two-shaft joint damping disk of a robot with a stiffness enhancing mechanism according to one or more embodiments of the present disclosure.

FIG. 3 is a schematic diagram of a passing manner of damping cable in a pulley block of a robot with a stiffness enhancing mechanism according to one or more embodiments of the present disclosure.

FIG. 4 is an exploded view of a main-arm bracket of a robot with a stiffness enhancing mechanism according to one or more embodiments of the present disclosure.

FIG. 5 is an exploded view of an auxiliary-arm bracket of a robot with a stiffness enhancing mechanism according to one or more embodiments of the present disclosure.

FIG. 6 is an exploded view of a base bracket of a robot with a stiffness enhancing mechanism according to one or more embodiments of the present disclosure.

FIG. 7 is an exploded view of a tension device of a robot with a stiffness enhancing mechanism according to one or more embodiments of the present disclosure.

FIG. 8 is an exploded view of a tension movement device of a robot with a stiffness enhancing mechanism according to one or more embodiments of the present disclosure.

FIG. 9 is an exploded view of a damper assembly of a robot with a stiffness enhancing mechanism according to one or more embodiments of the present disclosure.

FIG. 10 is an exploded view of a sliding damping device of a robot with a stiffness enhancing mechanism according to one or more embodiments of the present disclosure.

FIG. 11 is an exploded view of a closed cable assembly of a robot with a stiffness enhancing mechanism according to one or more embodiments of the present disclosure.

FIG. 12 is an assembly diagram of a robot with a stiffness enhancing mechanism according to one or more embodiments of the present disclosure when the robot is in a zero posture.

FIG. 13 is an assembly diagram of a robot with a stiffness enhancing mechanism according to one or more embodiments of the present disclosure when the robot is in an extreme position.

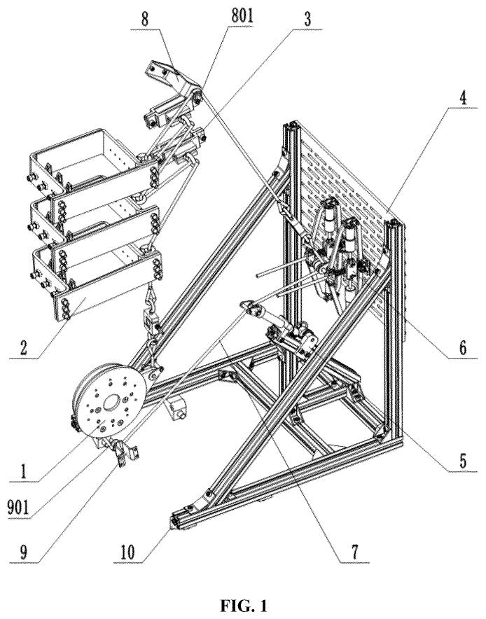

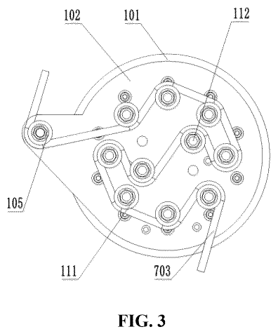

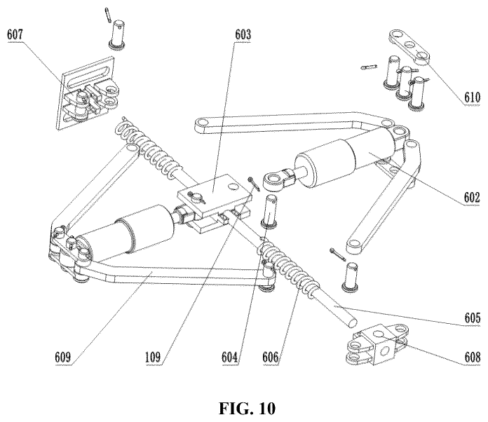

In FIGS. 1-13, spacing or dimensions between two components are exaggerated to display positions of the components, and the schematic diagram is only for illustration purposes.

### REFERENCE NUMERALS

1. two-shaft joint damping disk; 2. main-arm bracket; 3. auxiliary-arm bracket; 4. base bracket; 5. tension device; 6. damper member; 7. closed cable assembly; 8. first-guide pulley bracket; 9. second-guide pulley bracket; 10. fixing bracket; 11. base; 12. first arm; 13. second joint; 14. second-linkage main arm; 15. parallel-linkage auxiliary arm; 16. third joint; 17. fourth linkage; 18. end actuator;
101. switch disk; 102. pulley-block basement; 103. pulley block; 104. pulley-block top cap; 105. guide pulley; 106. blocking sheet; 107. pin; 108. blocking tube; 109. splitpin; 110. pulley fastening nut; 111. third pulley; 112. fourth pulley;
201. main-arm-bracket base plate; 202. main-arm-bracket U-shaped plate; 203. first bolt; 204. first nut; 205. main-arm rubber non-slip mat; 206. adjustment bolt; 207. welding nut; 208. fastening hinge point; 209. sheet for tighten claw; 210. main-arm hanging fixing; 211. second bolt; 212. second nut; 213. third nut; 214. hanging bolt;
301. auxiliary-arm-bracket U-shaped plate; 302. auxiliary-arm rubber non-slip mat; 303. auxiliary-arm hanging fixing;
401. first support frame; 402. second support frame; 403. third support frame; 404. third bolt; 405. ship type nut; 406. right-angle corner bracket; 407. acute-angle corner bracket; 408. obtuse-angle corner bracket; 409. installing plate;
501. fourth support frame; 502. fifth support frame; 503. splint; 504. deep groove ball bearing; 505. gear shaft; 506. rotating wheel; 507. rack; 508. fourth bolt; 509. cylinder clasping shaft; 510. first clamping block; 511. second clamping block; 512. locking bolt;
601. tension pulley; 602. viscous damper; 603. damper central block; 604. pin roll; 605. damper central rod; 606. tension spring; 607. damper pedestal; 608. damper position-limiting block; 609. connecting rod; 610. connecting mat;
701. first pulling-force sensor; 702. second pulling-force sensor; 703. damping cable; 7031. first-section damping cable; 7032. second-section damping cable;
801. first pulley; 901. second pulley.

### DETAILED DESCRIPTION OF THE EMBODIMENTS

It should be noted that following detailed explanations are illustrative and intended to provide further clarification of the present disclosure. Unless otherwise specified, all technical and scientific terms used in the present disclosure have the same meanings as those commonly understood by those skilled in the art to which the present disclosure belongs.

It should be noted that the terms used here are only for describing specific embodiments and are not intended to limit exemplary embodiments according to the present disclosure. As used herein, unless otherwise explicitly stated in the present disclosure, the singular form is also intended to include the plural form. In addition, it should be understood that when the terms “containing” and/or “including” are used in this specification, they indicate the presence of features, steps, operations, devices, assemblies, and/or combinations thereof.

As introduced in the background art, there is a problem of low-frequency flutter during a motion process of robot in the existing technology. In order to solve the above technical problem, the present disclosure proposes a stiffness enhancing mechanism for a robot.

### Embodiment 1

In a typical embodiment of the present disclosure, as shown in FIG. 1, the stiffness enhancing mechanism for a robot includes the base 11 that rotatably supports the first arm 12 via the first joint. The first arm 12 is connected to the second-linkage main arm 14 via the second joint 13, and the parallel-linkage auxiliary arm 15 is provided at side of the second-linkage main arm 14. The second-linkage main arm 14 and the parallel-linkage auxiliary arm 15 are connected to the third arm via the third joint 16, and the third arm is connected to the fourth linkage 17. The end actuator 18 is provided at end of the robot. The stiffness enhancing mechanism includes the base bracket 4 provided at the first joint of the robot, and the base bracket 4 supports the damper component 6. The two-shaft joint damping disk 1 is arranged at the second joint 13 of the robot, and the pulley block 103 is arranged at the two-shaft joint damping disk 1. The main-arm bracket 2 is arranged at the second-linkage main arm 14 of the robot, and the auxiliary-arm bracket 3 is arranged at the parallel-linkage auxiliary arm 15 of the robot (the parallel-linkage auxiliary arm 15 is located at one side of the second-linkage main arm 14). The damping cable 703 is connected to the main-arm bracket 2 and the auxiliary-arm bracket 3, and then wound at the damper component 6 and passes through the tension device 5 and wound around the pulley block at the two-shaft joint damping disk 1 to change the torque direction of the damping cable via the pulley block. The damping cable 703 provides the damping torque to the robot.

In this embodiment, the two-shaft joint damping disk 1 is fixed to the preset threaded hole at the second joint 13 of the robot via bolts, coinciding with the central axis line of the second joint 13. Multiple main-arm brackets 2 are evenly arranged on the second-linkage main arm 14 of the robot according to requirements, and the number of the main-arm brackets 2 is greater than or equal to two. At least one auxiliary-arm bracket 3 is evenly arranged at the parallel-linkage auxiliary arm 15 of the robot according to requirements. The main-arm bracket 2 and the auxiliary-arm bracket 3 are arranged in a staggered manner, that is, the position of the first auxiliary-arm bracket 3 is higher than the position of the first main-arm bracket 2, and the number of the main-arm brackets 2 is one more than the number of auxiliary-arm brackets 3. The damping cable 703 is sequentially wound around the pulley block 103 and the guide pulley 105 in the two-shaft joint damping disk 1, the main-arm bracket 2, and the auxiliary-arm bracket 3, to form a closed loop, thus forming the closed cable assembly 7.

In addition, the tension device 5 changes the extension length of the damping cable 703, thereby adjusting the initial pre-tension force of the closed cable assembly 7. The use of the damper component 6 compensates for the dynamic changes in the position of the damping cable 703 during a robot motion process, preventing excessive extension of the cable that may cause breakage. And the variation in the extension length of the damper member 6 can provide continuous and stable interval damping force for the closed cable assembly 7.

It should be noted that considering the interference between the damping cable 703 and the robot structural components when the damping cable 703 passes through the two-shaft joint damping disk 1 and the main-arm bracket 2, in order to adjust the passing path of the damping cable 703, the first-guide pulley bracket 8 is arranged at the hinge-point position on the parallel-linkage auxiliary arm of the robot, the first pulley 801 is arranged at the first-guide pulley bracket 8, and the second-guide pulley bracket 9 is arranged below the second joint 13 of the robot. The second pulley 901 is arranged at the second-guide pulley bracket 9, and each of the two sides of the second pulley 901 is fixed to the second-guide pulley bracket 9 via the pulley fastening nut.

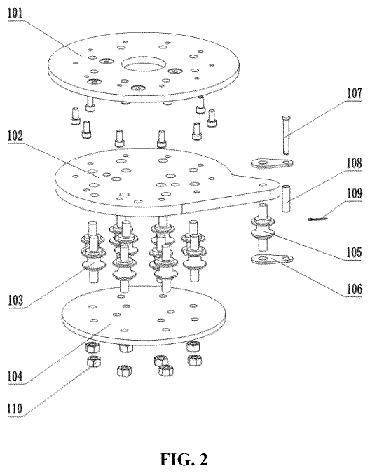

Referring to FIGS. 2, 3, and 12, the two-shaft joint damping disk 1 is sequentially provided with the switch disk 101, the pulley-block basement 102, the pulley block 103, and the pulley-block top cap 104 along the axis line direction of the second joint of the robot. The switch disk 101 is provided with bolt through holes according to the arrangement manner of threaded holes on the second joint of the robot. The switch disk 101 is fixed to the second joint 13 of the robot via the bolts. After installation, it is ensured that the central axis line of the switch disk 101 coincides with the central axis line of the second joint of the robot. The pulley-block basement 102 is fixed to the switch disk 101 via the bolts, and multiple pulley installing holes (the third pulley installing holes and the fourth pulley installing holes) are arranged on the pulley-block basement 102 to fix and install the pulley block 103.

Specifically, the third pulley installing holes are uniformly arranged along the circumferential direction of the pulley-block basement 102. Eight third pulley installing holes are arranged, and the axial-directional distributed eight pulley installing holes need to be installed with the third pulleys 111. The fourth pulley installing holes are arranged near the axis line of the pulley-block basement 102, and there are four fourth pulley installing holes. The centers of these four pulley installing holes are distributed in a rectangular shape, and only two fourth pulleys 112 need to be installed in the diagonal direction according to the requirements. In this way, ten pulleys are arranged at the pulley-block basement 102 to form the pulley block 103. The damping cable 703 winds around a portion of the third pulleys (such as four third pulleys) in circumferential direction and then winds around two fourth pulleys 112. Afterwards, the damping cable 703 continues to wind around the remaining third pulleys 111, so that the damping cable 703 is connected to the pulley block 103 arranged in the multiple pulley installing holes in series, the internal forces in the damping cable 703 can be converted into joint damping torque, thereby suppressing torque fluctuations caused by nonlinear friction and gases in the joints.

The damping cable 703 winds around the first fourth pulley 112 and then reverses direction before winding around the second fourth pulley 112.

In this embodiment, the pulley-block top cap 104 is provided with fixing holes at the positions of the third pulley installing hole and the fourth pulley installing hole on the pulley-block basement 102, and the pulley-block top cap 104 is fixed to the unfixed end of the pulley block 103 via the pulley fastening nut 110. After the installation of the switch disk 101, the pulley-block basement 102, and the pulley-block top cap 104, the central axis lines of the switch disk 101, the pulley-block basement 102, and the pulley-block top cap 104 are completely aligned.

It is easy to understand that in the direction of the series connection of the damping cable 703 from the two-shaft joint damping disk 1 to the main-arm bracket 2, the fifth pulley installing holes are arranged on the extended platform of the pulley-block basement 102, and the guide pulley 105 is installed via the third pulley installing holes. The stop component is arranged at the guide pulley 105, the stop component includes the blocking sheet 106 arranged at both ends of shaft of the guide pulley. The blocking tube 108 is connected in series with the pin 107 in the outer hole of the blocking sheet 106 to prevent the damping cable 703 from slipping out of the groove, and the pin 107 is fixed via the splitpin 109.

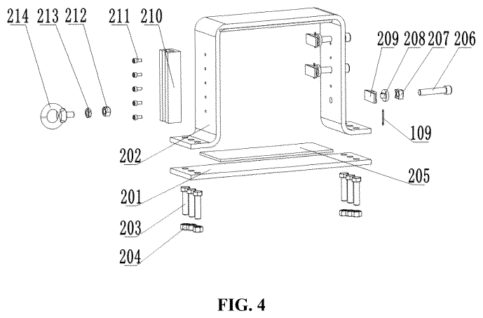

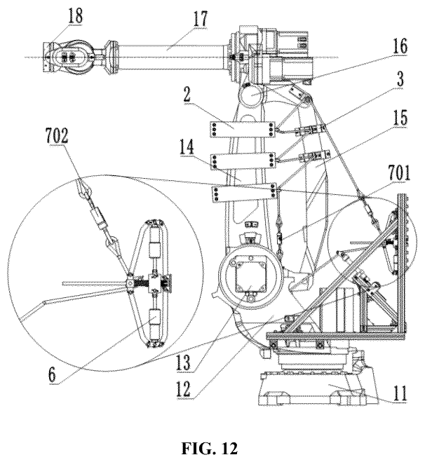

To ensure the universality of the robot and avoid destructive modifications for the robot, three sets of main-arm brackets 2 are arranged on the second-linkage main arm 14 of the robot to provide application points of the damping force. Adjacent two main-arm brackets 2 are arranged in an interval distance. As shown in FIGS. 4 and 12, the main-arm bracket 2 includes the main-arm-bracket base plate 201 and the main-arm-bracket U-shaped plate 202. After fit installation of the main-arm-bracket base plate 201 and the main-arm-bracket U-shaped plate 202, the rectangular cross-section of the middle cavity is slightly larger than the cross-section of the second-linkage main arm 14 of the robot. Three bolt through holes are arranged at the fit position of the main-arm-bracket base plate 201 and the main-arm-bracket U-shaped plate 202, and the second-linkage main arm 14 of the robot is locked by the first bolt 203 and the first nut 204. The main-arm-bracket base plate 201 and the main-arm-bracket U-shaped plate 202 are fitted with sides of the mechanical arm and arranged with main-arm rubber non-slip mat 205 via the glue manner. The main-arm rubber non-slip mat 205 can prevent wear or scratches caused by hard contact between the main-arm bracket 2 and the second-linkage main arm of the robot. And the elastic deformation of the main-arm rubber non-slip mat 205 can increase friction and prevent the main-arm bracket 2 from sliding with the second-linkage main arm 14 of the robot after being pulled by the damping cable 703. The thickness and shape of the main-arm rubber non-slip mat 205 are selected according to the installation effect, and are not specifically limited here.

Due to the curved side of the second-linkage main arm 14 of the robot, the cross-sectional shape is not fixed. In order to ensure the complete fixation of the main-arm bracket 2 and the robot, three sets of adaptive tighten claws are arranged on the side of the main-arm bracket 2 near the end actuator of the robot to prevent the main-arm bracket 2 from sliding along the direction of the axis line of the fourth linkage 17 of the robot. Three positioning installing holes are arranged on the side of the main-arm-bracket U-shaped plate 202 of the corresponding side for installing the adaptive tighten claws. The adaptive tighten claw includes the adjustment bolt 206, the welding nut 207, the fastening hinge point 208, and the sheet for tighten claw 209. The welding nut 207 is fixed on the positioning installing hole of the main-arm-bracket U-shaped plate 202 via the welding manner. The adjustment bolt 206 passes through the welding nut 207, and the end of the adjustment bolt 206 is connected to the fastening hinge point 208 via the thread. The fastening hinge point 208 is fixed to the sheet for tighten claw 209 via the hinge manner, and the hinge hole is installed via the splitpin 109. The sheet for tighten claw 209 is closed to the side of the mechanical arm and is arranged with rubber non-slip mat via the glue manner to increase the fastening force. The tightness degree between the sheet for tighten claw 209 and the side of the mechanical arm is adjusted by tightening the adjustment bolt 206. And the sheet for tighten claw 209 rotates along the fastening hinge point 208 to adapt to the curvature of the side of the mechanical arm.

Specifically, as shown in FIG. 4, the side of the main-arm bracket 2 away from the end actuator of the robot is provided with the main-arm hanging fixing 210, and the side of the main-arm-bracket U-shaped plate 202 of the corresponding side is uniformly provided with five threaded holes. The interior of the main-arm hanging fixing 210 is provided with the convex cavity, and five bolt countersunk holes are arranged inside the convex cavity, and the five bolt countersunk holes are fixed on the main-arm-bracket U-shaped plate 202 via the second bolts 211. The interior of the convex cavity is provided with the second nuts 212, and the outer side of the convex cavity is provided with the third nuts 213. The rotation direction of the thread of the second nut 212 is opposite to that of the third nut 213. The hanging bolt 214 passes through the third nut 213 and the convex cavity in sequence and is screwed into the second nut 212. The hanging bolt 214 can adjust the fixed position along the cavity of the main-arm hanging fixing 210 according to the passing manner of the damping cable 703. The hanging bolt 214 is screwed can clamp the main-arm hanging fixing 210 with the second nut 212 and the third nut 213, thereby preventing the hanging bolt 214 from moving due to the traction force of the damping cable 703.

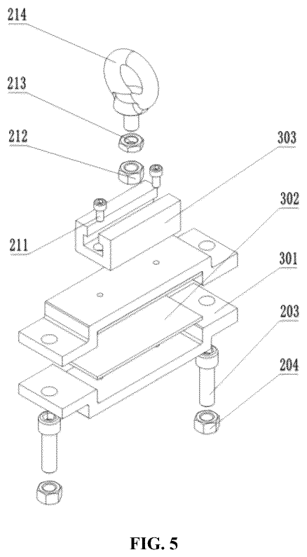

Referring to FIGS. 5 and 12, two sets of auxiliary-arm brackets 3 are arranged on the parallel-linkage auxiliary arm of the robot. The auxiliary-arm brackets 3 provide application points of the damping force for the damping cable 703. The auxiliary-arm bracket 3 includes two auxiliary-arm-bracket U-shaped plates 301 that are arranged opposite to each other. After fit installation of the two auxiliary-arm-bracket U-shaped plates 301, the rectangular cross-section of the middle cavity is slightly larger than the cross-section of the parallel-linkage auxiliary arm of the robot. One bolt through hole is provided at the fit portion of each of the two auxiliary-arm-bracket U-shaped plates 301, and the parallel-linkage auxiliary arm 15 of the robot is locked by another first bolt 203 and the first nut 204. The auxiliary-arm-bracket U-shaped plate 301 is fitted with the side of the parallel auxiliary arm and is provided with the auxiliary-arm rubber non-slip mat 302 via the glue manner. The effect of the auxiliary-arm rubber non-slip mat 302 is same as that of the main-arm rubber non-slip mat 205. The thickness and shape of the rubber non-slip mat are selected according to the installation effect and are not specifically limited here.

It is easy to understand that the side of the auxiliary-arm bracket 3 close to the second-linkage main arm of the robot is provided with the auxiliary-arm hanging fixing 303, and the side of the auxiliary-arm-bracket U-shaped plate 301 of the corresponding side is provided with two threaded holes. The interior of the auxiliary-arm hanging fixing 303 is also provided with the convex cavity, and the interior of the second convex cavity is provided with two threaded countersunk holes. The second bolt 211 is fixed on the auxiliary-arm-bracket U-shaped plate 301. The second nut 212 is provided inside the convex cavity, and the third nut 213 is provided outside the convex cavity. The installation manner of the auxiliary-arm hanging fixing 303 on the auxiliary-arm bracket 3 is same as that of the main-arm hanging fixing 210 in the main-arm bracket 2.

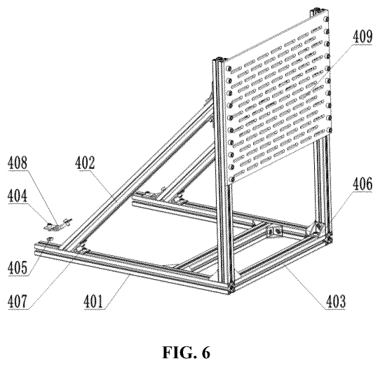

Referring to FIGS. 6 and 12, in order to reduce the impact of the stiffness enhancing mechanism on the working range of industrial robots, four fixing brackets 10 are installed at the multiple threaded installing holes reserved at the first joint of the robot. The base bracket 4 is fixed to the first joint of the robot via the fixing brackets 10. The base bracket 4 is connected to the fixing bracket 10 via the third bolt 404 and the ship type nut 405, so that the stiffness enhancing mechanism can rotate with the rotation of the axis joint of the robot without interference. The fixing bracket specifically can be the support block.

In this embodiment, the main body of the base bracket 4 consists of four first support frames 401 with a length of 900 mm, two second support frames 402 with a length of 1060 mm and 45° oblique sections at both ends, and two third support frames 403 with a length of 611 mm. The size parameters of the cross section of the support frames are selected according to actual installation requirements and are not specifically limited here.

The four first support frames 401 and the two second support frames 402 form two sets of right-angle triangular frames. One third support frame 403 is arranged at the right-angle point of the two sets of triangular frames for connection, and another third support frame 403 is arranged as the reinforcement beam between the two first support frames 401 connected to the fixing frame according to the actual installation conditions. Adjacent two aluminum profiles are connected with each other with the right-angle corner bracket 406, the acute-angle corner bracket 407, or the obtuse-angle corner bracket 408 according to the angle space. The first support frame 401 is provided with the installing plate 409 along the direction perpendicular to the bottom surface of the robot base. The installing plate 409 is provided with 15 rows of horizontal installing holes parallel to the third support frame 403. The horizontal installing holes between different rows are distributed in the staggered manner, and installing holes can be selected as needed to facilitate the adjustment of the position of the damper member 6. The various support frames, corner brackets, and installing plates 409 in the base bracket 4 are fixed via the ship type nuts 405 and the third bolts 404.

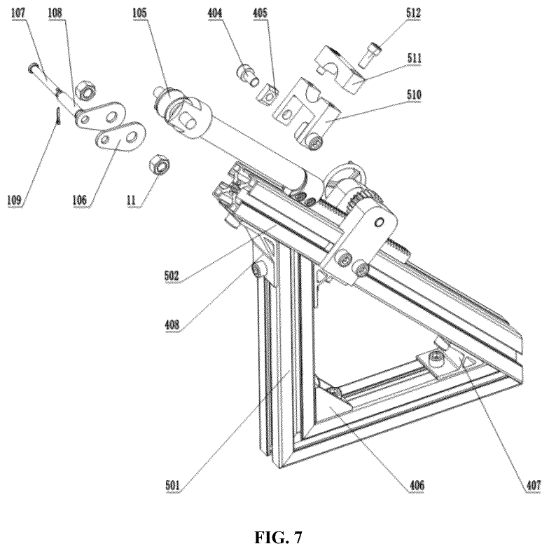

It should be explained that the tension device 5 includes the tension bracket, the tension adjustment assembly, and the tension clamping assembly. As shown in FIG. 7, the tension bracket consists of two fourth support frames 501 with a length of 300 mm and 45° oblique section at both ends, and one fifth support frame 502 with a length of 500 mm and 45° oblique section at one end. The two fourth support frames 501 are placed vertically, and the fifth support frame 502 is added as a hypotenuse to form the right-angle triangular frame, the frames are connected by different included-angle corner brackets, the third bolts 404, and the ship type nuts 405. The tension bracket is vertically arranged between the two third support brackets 403 of the base bracket 4, and is connected by the corner brackets, the third bolts 404, and the ship type nuts 405. The right-angle point of the tension bracket is arranged on the third support frame 403 near the end actuator side of the robot. By disassembling the bolts, the tension bracket can move laterally along the third support frame 403, facilitating adjustment of position of the tension device 5.

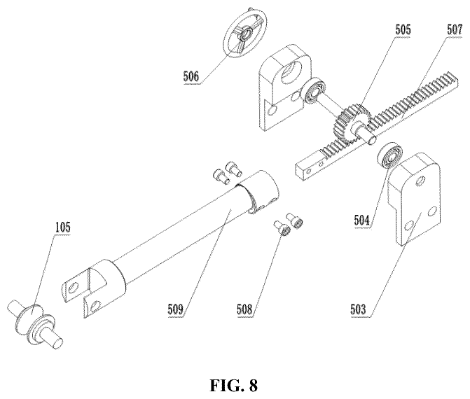

As shown in FIG. 8, the tension adjustment assembly includes two splints 503 symmetrically fixed on the fifth support frame 502 via the third bolt 404 and the ship type nut 405. The splints 503 are provided with bearing seat holes, and deep groove ball bearings 504 are arranged in the bearing seat holes. The gear shaft 505 arranged in the middle of the two splints 503 passes through the deep groove ball bearings 504 for connection, with one end passing through the splint 503 and fixedly connected to the rotating wheel 506 via threads. The side of the fifth support frame 502 can be slidely provided with the rack 507, which meshes with the gear shaft 505. The rack 507 has four threaded holes near the end actuator side of the robot, and the four threaded holes are fixedly connected to the cylinder clasping shaft 509 via the fourth bolts 508. The pulley groove is arranged at the end of the cylinder clasping shaft 509, and the fifth pulley is fixed between the pulley grooves via the pulley fastening nut. Similar to the guide pulley 105 arranged on the extended platform of the two-shaft joint damping disk 1, the blocking sheet 106 and the blocking tube 108 are arranged at both ends of the pulley, and the pin 107 is arranged through the blocking tube. The damping cable winds around the pulley and passes through the blocking tube to prevent the damping cable 703 from slipping out of the groove.

It is easy to understand that the tension adjustment assembly can slide along the fifth support frame 502. After preliminarily determining the position of the tension adjustment assembly according to specific needs, the rotating wheel 506 is shook, and the gear shaft 505 and the rotating wheel 506 are rotated synchronously. The rack 507 moves back and forth with the gear at the gear shaft 505, and the extension length of the cylinder clasping shaft 509 also changes with the movement of the rack 507, thereby adjusting the pre-tension degree of the damping cable 703.

In addition, the cylinder clasping shaft 509 is provided with the tension clamping assembly, which includes the first clamping block 510 and the second clamping block 511. The first clamping block 510 is fixed to the fifth support frame 502 via the third bolt 404 and the ship type nut 405, and the second clamping block 511 is fixed to the first clamping block 510 via two locking bolts 512. The joint position of the two clamping blocks is provided with an arc-shaped hole, a through hole is formed by two arc-shaped plates and the diameter of the through hole is smaller than that of the cylinder clasping shaft 509. After the initial adjustment of the pre-tension force of the damping cable 703 is completed, the two locking bolts 512 can be tightened to make the two clamping blocks clasp the cylinder clasping shaft 509 tightly, thereby preventing the tension device 5 from moving.

It is easy to understand that all components in the tension bracket and the base bracket 4 can be made of existing industrial aluminum profiles, making installation convenient.

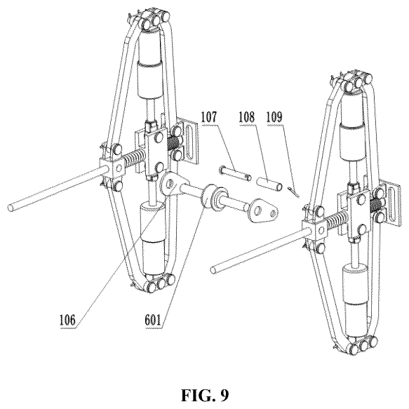

Referring to FIGS. 9, 10, and 11, the damper member 6 includes two sliding damping assemblies and one tension pulley 601. A tension pulley is arranged between the two sliding damping assemblies. The tension pulley 601 is similar to the guide pulley 105 arranged on the extended platform of the two-shaft joint damping disk 1. The blocking sheet 106 and the blocking tube 108 are arranged on the side of the tension pulley 601 to prevent the damping cable 703 from slipping out of the groove at the tension pulley 601. The damper member 6 is fixed to the installing plate via the bolts and the nuts. The sliding damping assembly can automatically adjust the motion range of the damping cable according to the movement state of the mechanical arm during the machining process, and effectively apply stable damping force to the damping cable.

Specifically, the sliding damping assembly includes two dampers arranged in a same axis line, with viscous damper 602 selected as the damper. The two viscous dampers 602 are symmetrically distributed along the first axis line, which is perpendicular to the axis line of the viscous damper 602. The viscous damper 602 is the magneto rheological damper that can actively control the current to change the damping strength according to the modal matching requirements of the robot structure during use. The center of symmetry of the two viscous dampers 602 is provided with the damper central block 603. The damper central block 603 is hinged to the end of the piston rod via the pin roll 604 and the splitpin 109. Based on the arrangement of the damper, the sliding damping assembly provides continuous internal damping force for the damping cable 703 during the working process of the robot, and compensates for the spatial position changes of the damping cable 703.

In this embodiment, the guide hole is arranged in the middle of the damper central block 603, and the damper central rod 605 is arranged inside the guide hole. The damper central rod 605 provides sliding support for the sliding damping assembly. Tension springs 606 are arranged on both sides of the damper central rod 605 along the first axis line, and the tension springs 606 pass through the damper central rod. One end of the damper central rod 605 is provided with the damper pedestal 607, the one end of the damper central rod 605 and the damper pedestal 607 are connected and fixed via threads. The damper pedestal 607 is fixed to the installing plate 409 via the bolts and the nuts. The other end of the damper central rod is provided with the damper position-limiting block 608. A guide hole is arranged at the center of the damper position-limiting block 608 for the unfixed side of the damper central rod 605 to pass through. The position of the tension spring is limited via the damper position-limiting block. Two tension springs 606 are arranged, one of which is located between the damper position-limiting block 608 and the damper central block 603, and the other one of which is located between the damper central block 603 and the damper pedestal 607. The position-limiting ear plates screwed in the damper position-limiting block 608, the damper central block 603, and the damper pedestal 607 are used for connection.

A threaded hole is arranged on the side of the damper position-limiting block 608, and the damper position-limiting block 608 is fixedly connected to the tension pulley 601 in the damper member 6 via the threads. Two connecting rods 609 are arranged between the end of the viscous damper 602 and the damper position-limiting block 608, and two connecting rods 609 are arranged between the end of the viscous damper 602 and the damper pedestal 607. The pin roll 604 and the splitpin 109 are hinged to the end of the viscous damper 602 via the connecting mat 610. The connecting ear seats are arranged at the damper position-limiting block 608 and the damper pedestal 607. The damper position-limiting block 608 and the damper pedestal 607 each passes through the pin roll 604, the splitpin 109, and the connecting ear seat and hinges to the connecting rod 609. After the installation of the four connecting rods 609, a diamond-shaped hinged linkage mechanism is formed to ensure the stability of the structures of the damper member.

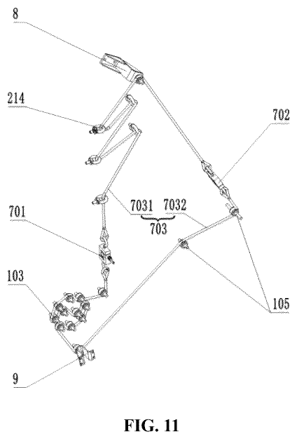

As shown in FIGS. 11 and 12, the passing manner of the damping cable 703 is related to the number and position of the main-arm bracket 2 and the auxiliary-arm bracket 3. In this embodiment, three main-arm brackets 2 and two auxiliary-arm brackets 3 are arranged. The position of the hanging bolts 214 of the main-arm bracket 2 and the auxiliary-arm bracket 3 is adjusted to the appropriate position according to the actual application scenes, ensuring that the first hanging bolt at the main-arm bracket is in the same plane as the connected guide pulley 105 (the plane is parallel to the side of the second main arm of the robot), preventing the damping cable 703 from slipping out of the groove during the working process.

In addition, the closed cable assembly 7 also includes the first pulling-force sensor 701, the second pulling-force sensor 702, and the damping cable 703. The damping cable 703 can be divided into the first-section damping cable 7031 and the second-section damping cable 7032.

The arrangement of the stiffness enhancing mechanism includes the following steps. The first-section damping cable 7031 is connected to the second pulling-force sensor 702 after passing through the hanging bolt 214 of the main-arm bracket 2 and the hanging bolt 214 of the auxiliary-arm bracket 3 (the passing manner is the cross sequential-passing manner), and the first pulley at the first-guide pulley bracket 8 in sequence. The second-section damping cable 7032 passes through the pulley block 103 on the two-shaft joint damping disk 1, the second pulley on the second-guide pulley bracket 9, the fifth pulley on the tension device 5, and the tension pulley 601 on the damper member 6 in sequence. The first end of the first-section damping cable 7031 is connected to the first end of the second-section damping cable 7032 via the first pulling-force sensor 701, and the second end of the first-section damping cable 7031 is connected to the second end of the second-section damping cable 7032 via the second pulling-force sensor 702.

To ensure better flutter suppression efficiency, the damping cable 703 can be made of plant fiber rope, chemical fiber rope, or steel wire rope. It can be understood that according to the characteristics of the cable material, there are also significant differences in its modal frequency. Before selection, according to modal frequency of the robot's joints, multiple physical field simulations and experimental tests should be conducted to ensure the parameters of cable and the modal matching characteristics between the joints, so as to form resonance between the damping cable and the joints, and absorb the flutter energy on the joints to the cable for dissipation. The selection method of the damping cable 703 already has mature technology, and will not be introduced in detail here.

### Embodiment 2

This embodiment discloses a working method for stiffness enhancing mechanism of robot. The working method includes following steps.

As shown in FIGS. 11 and 12, the robot is in a zero position posture. Due to the pulling force provided by the tension spring 606 in the damper member 6, the tension pulley 601 is in a retracted state, and the piston rod of the viscous damper 602 is mostly extended, but still provides internal damping force for the closed cable assembly 7. The tension device 5, according to actual application needs, contacts and deforms the damping closed cable assembly 7 and to provide initial tension force.

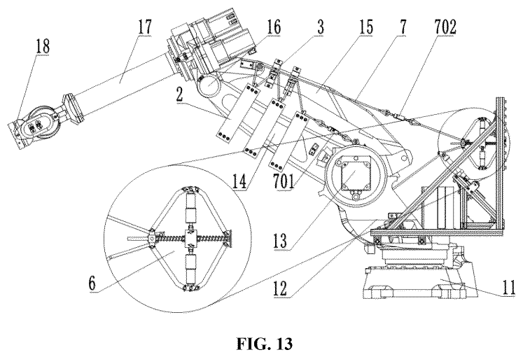

As shown in FIG. 13, the end actuator of the robot in this embodiment is located at the farthest point in the workspace, and there is no significant positional change due to the locking of the main-arm bracket 2 and the auxiliary-arm bracket 3. The tension spring in the damper member 6 is stretched to its limit position due to the traction of the closed cable assembly 7. At this time, the tension pulley 601 is in a fully stretched state, and most portion of the piston rod of the viscous damper 602 is retracted, but it still provides internal damping force for the closed cable assembly 7. And at this time, the damper member 6 compensates for the spatial position changes of the closed cable assembly 7, so there is no significant change in the tension state of the damping cable 703.

Specifically, the tension device 5, the hanging bolt 214, the guide pulley 105, the damper member 6, and the damping cable 703 can be adjusted according to actual needs until the readings of the first pulling-force sensor 701 and the second pulling-force sensor 702 are similar and within the preset range.

In an ideal state, the readings on the first pulling-force sensor 701 and the second pulling-force sensor 702 are exactly the same. However, in practical situations, the tension device 5 can only ensure modal matching of the robot in the initial state. After machining begins, due to changes in the spatial position of the damping cable 703 and frictional forces on the contact surface, there may be deviations in the readings on the first pulling-force sensor 701 and the second pulling-force sensor 702. Therefore, when the damping cable 703 is installed, lubricating medium should be applied to surface of the damping cable 703 to reduce the friction coefficient, and an active feedback control strategy should be adopted to adjust the damping strength of the viscous damper 602 in real time, achieving real-time modal matching between the damping cable 703 and the joints of the robot.

The aforementioned embodiments are only preferred embodiments of the present disclosure and are not intended to limit the present disclosure. For those skilled in the art, the present disclosure may have various modifications and variations. Any modifications, equivalent substitutions, improvements, etc. made within the spirit and principles of the present disclosure shall be included within the scope of protection of the present disclosure.

What is claimed is:

1. A stiffness enhancing mechanism for a robot, comprising: a base, and a base bracket arranged at a first joint of a robot;
wherein the base rotatably supports a first arm via the first joint, the first arm is connected to a second-linkage main arm via a second joint, a side of the second-linkage main arm is provided with a parallel-linkage auxiliary arm, the second-linkage main arm and the parallel-linkage auxiliary arm are connected to a third arm via a third joint, and the third arm is connected to a fourth linkage;
wherein the base bracket supports a damper member, and a two-shaft joint damping disk is provided at the second joint of the robot, a pulley block is provided at the two-shaft joint damping disk, a main-arm bracket is provided at the second-linkage main arm of the robot, an auxiliary-arm bracket is provided at the parallel-linkage auxiliary arm of the robot, a damping cable is wound at the damper member after connected to the main-arm bracket and the auxiliary-arm bracket,
wherein the damping cable passes through a tension device and is wound at the pulley block of the two-shaft joint damping disk to change a torque direction of the damping cable via the pulley block, the damping cable provides a damping torque to the robot;
wherein the two-shaft joint damping disk comprises a pulley-block basement, the pulley-block basement is connected to the second joint in a same axis line, and the pulley-block basement supports the pulley block;
wherein the pulley block comprises third pulleys and fourth pulleys,
wherein a plurality of third pulleys are arranged along a circumferential direction of the pulley-block basement, and at least two fourth pulleys are arranged inside an area enclosed by connection of adjacent two third pulleys of all third pulleys,
wherein one side of the pulley block is protruded, a guide pulley is arranged at a protruded position of the pulley-block basement, the damping cable passes first through a portion of the third pulleys, then through the fourth pulleys, then through a remaining portion of the third pulleys, and then through the guide pulley in sequence, so that a direction of a section of the damping cable located between the guide pulley and the main-arm bracket and a direction of the second-linkage main arm is same;
wherein at least two main-arm brackets are arranged such that the main-arm brackets are fixed at a circumferential direction of the second-linkage main arm,
wherein a hanging bolt is installed at a side of a main-arm bracket,
wherein the damping cable passes through the hanging bolt of the main-arm bracket, and the hanging bolt is installed at the main-arm bracket via a main-arm hanging fixing;
wherein at least one auxiliary-arm bracket is arranged in a staggered manner with the main-arm bracket,
wherein the auxiliary-arm bracket is fixed at a circumferential direction of the parallel-linkage auxiliary arm, the hanging bolt is installed at a side of the auxiliary-arm bracket, the damping cable passes through the hanging bolt located at the auxiliary-arm bracket, and the hanging bolt is installed at the auxiliary-arm bracket via an auxiliary-arm hanging fixing.

2. The stiffness enhancing mechanism for a robot according to claim 1, further comprising a first pulley and a second pulley; wherein the first pulley is arranged at a hinge position between the parallel-linkage auxiliary arm and the second-linkage main arm, the second pulley is arranged below the two-shaft joint damping disk, and the damping cable is wound around the first pulley and the second pulley to change a direction of the damping cable via the first pulley and the second pulley.

3. The stiffness enhancing mechanism for a robot according to claim 2, wherein the damping cable comprises a first-section damping cable and a second-section damping cable;
wherein the first-section damping cable passes through the main-arm bracket, the auxiliary-arm bracket, and the first pulley in sequence, and wherein the second-section damping cable passes through the pulley block, the second pulley, the tension device, and the damper member in sequence, and wherein the first-section damping cable and the second-section damping cable are connected via pulling-force sensors to form a closed cable assembly.

4. The stiffness enhancing mechanism for a robot according to claim 1, wherein the protruded position of the pulley-block basement is further provided with a stop component, the stop component is connected between a pulley shaft of the guide pulley and the protruded position of the pulley-block basement, so that an interval distance between the stop component and the guide pulley is set to limit a position of the damping cable.

5. The stiffness enhancing mechanism for a robot according to claim 1, wherein a structure of the main-arm hanging fixing and a structure of the auxiliary-arm hanging fixing are same, each of the main-arm hanging fixing and the auxiliary-arm hanging fixing comprises a convex cavity, the convex cavity is provided with a second nut, a third nut is arranged at side of the convex cavity, and the hanging bolt passes through the third nut and the second nut in sequence.

6. The stiffness enhancing mechanism for a robot according to claim 5, wherein an adaptive tightening claw is arranged at side of the main-arm bracket; wherein the adaptive tightening claw comprises an adjustment bolt, the adjustment bolt passes through a welding nut and the side of the main-arm bracket, the welding nut is fixed at the side of the main-arm bracket, end of the adjustment bolt is connected to a fastening hinge point, the fastening hinge point is hinged and connected to a sheet for tighten claw, and the sheet for tightening claw rotates along the fastening hinge point to adapt to the second-linkage main arm.

7. The stiffness enhancing mechanism for a robot according to claim 1, wherein the damper member comprises two sliding damping assemblies, a tension pulley is arranged between the two sliding damping assemblies, and the damping cable is wound around the tension pulley;
wherein each of the two sliding damping assemblies comprises two dampers arranged opposite to each other, an extendable end of each of the two dampers is connected to a damper central block, a damper central rod passes through the damper central block, an end of the damper central rod that passes through the damper central block is connected to base bracket, and an other end of the damper central block passes through a damper position-limiting block,
wherein each of two sides of the damper central rod located at the damper central block are provided with tension springs, a fixing end of each of the two dampers is connected to the base bracket via a connecting rod, and the fixing end of each of the two dampers is connected to the damper position-limiting block via a connecting rod.

8. The stiffness enhancing mechanism for a robot according to claim 1, wherein the tension device comprises a tension bracket, wherein the tension bracket is installed at the base bracket, and a position of the tension bracket relative to the base bracket is adjustable;
wherein the tension bracket supports a tension adjustment assembly and a tension clamping assembly;
wherein the tension adjustment assembly comprises a movement component, the movement component is slideably installed at the tension bracket, and the movement component is connected to a cylinder clasping shaft,
wherein one end of the cylinder clasping shaft away from the movement component is provided with a fifth pulley, the damping cable is wound around the fifth pulley to adjust a tension degree of the damping cab le via the movement component, and one side of the fifth pulley is provided with the stop component.

9. The stiffness enhancing mechanism for a robot according to claim 8, wherein the tension clamping assembly clamps the cylinder clasping shaft, and can lock the cylinder clasping shaft;
wherein the fifth pulley is located below the damper member, and the cylinder clasping shaft is inclined upward relative to bottom of the base bracket.

10. The stiffness enhancing mechanism for a robot according to claim 1, wherein the base bracket comprises a pedestal frame, the pedestal frame supports a vertical frame, and the vertical frame supports the fixing plate;
wherein the fixing plate is provided with a plurality of layers of installing holes, wherein installing holes in adjacent two layers are arranged in a staggered manner, and the damper member is installed at the fixing plate via the installing holes.

11. A working method for the stiffness enhancing mechanism for a robot according to claim 1, comprising:
arranging the base bracket at the first joint of the robot, wherein the base bracket supports the damper member, the two-shaft joint damping disk is arranged at the second joint, and the pulley block is arranged at the two-shaft joint damping disk;
wherein the main-arm bracket is arranged at the second-linkage main arm, and the auxiliary-arm bracket is arranged at the parallel-linkage auxiliary arm;
connecting the damping cable to the main-arm bracket and the auxiliary-arm bracket, winding the damping cable at the damper member, and winding the pulley block at the two-axis joint damping disk after passing through the tension device;
setting the robot in a zero position posture, providing an internal damping force to the damping cable by the damper member, and contacting the tension device to the damping cable according to actual needs and deforming the damping cable to provide an initial tension force; and
during working processes of the first arm, the second-linkage main arm, the parallel-linkage auxiliary arm, and the third arm of the robot, introducing damping torques to the second joint, the second-linkage main arm, and the parallel-linkage auxiliary arm by the damping cable to achieve dissipation of flutter energy of joint structures.

12. The working method according to claim 11, wherein the stiffness enhancing mechanism for a robot further comprises a first pulley and a second pulley; wherein the first pulley is arranged at a hinge position between the parallel-linkage auxiliary arm and the second-linkage main arm, the second pulley is arranged below the two-shaft joint damping disk, and the damping cable is wound around the first pulley and the second pulley to change a direction of the damping cable via the first pulley and the second pulley.

13. The working method according to claim 12, wherein the damping cable comprises a first-section damping cable and a second-section damping cable; wherein the first-section damping cable passes through the main-arm bracket, the auxiliary-arm bracket, and the first pulley in sequence, wherein the second-section damping cable passes through the pulley block, the second pulley, the tension device, and the damper member in sequence, and wherein the first-section damping cable and the second-section damping cable are connected via pulling-force sensors to form a closed cable assembly.

14. The working method according to claim 11, wherein the protruded position of the pulley-block basement is further provided with a stop component, wherein the stop component is connected between a pulley shaft of the guide pulley and the protruded position of the pulley-block basement, so that an interval distance between the stop component and the guide pulley is set to limit a position of the damping cable.

15. The working method according to claim 11, wherein a structure of the main-arm hanging fixing and a structure of the auxiliary-arm hanging fixing are same, wherein each of the main-arm hanging fixing and the auxiliary-arm hanging fixing comprise a convex cavity, wherein the convex cavity is provided with a second nut, wherein a third nut is arranged at a side of the convex cavity, and wherein the hanging bolt passes through the third nut and the second nut in sequence.

16. The working method according to claim 15, wherein an adaptive tightening claw is arranged at a side of the main-arm bracket;
wherein the adaptive tightening claw comprises an adjustment bolt, the adjustment bolt passes through a welding nut and the side of the main-arm bracket, the welding nut is fixed at the side of the main-arm bracket, an end of the adjustment bolt is connected to a fastening hinge point, the fastening hinge point is hinged and connected to a sheet for tightening claw, and the sheet for tightening claw rotates along the fastening hinge point to adapt to the second-linkage main arm.

17. The working method according to claim 11, wherein the damper member comprises two sliding damping assemblies,
wherein a tension pulley is arranged between the two sliding damping assemblies and the damping cable is wound around the tension pulley;
wherein each of the two sliding damping assemblies comprises two dampers arranged opposite to each other, an extendable end of each of the two dampers is connected to a damper central block, a damper central rod passes through the damper central block, an end of the damper central rod that passes through the damper central block is connected to base bracket, and an other end of the damper central block passes through a damper position-limiting block,
wherein each of two sides of the damper central rod located at the damper central block are provided with tension springs, a fixing end of each of the two dampers is connected to the base bracket via a connecting rod, and the fixing end of each of the two dampers is connected to the damper position-limiting block via a connecting rod.

18. The working method according to claim 11, wherein the tension device comprises a tension bracket, and the tension bracket is installed at the base bracket, and a position of the tension bracket relative to the base bracket is adjustable;
wherein the tension bracket supports a tension adjustment assembly and a tension clamping assembly;
wherein the tension adjustment assembly comprises a movement component, the movement component is slideably installed at the tension bracket, and the movement component is connected to a cylinder clasping shaft,
wherein one end of the cylinder clasping shaft away from the movement component is provided with a fifth pulley, the damping cable is wound around the fifth pulley to adjust a tension degree of the damping cable via the movement component, and one side of the fifth pulley is provided with the stop component.

19. The working method according to claim 18, wherein the tension clamping assembly clamps the cylinder clasping shaft, and can lock the cylinder clasping shaft;
wherein the fifth pulley is located below the damper member, and the cylinder clasping shaft is inclined upward relative to bottom of the base bracket.

20. The working method according to claim 11, wherein the base bracket comprises a pedestal frame, the pedestal frame supports a vertical frame, and the vertical frame supports the fixing plate;
wherein the fixing plate is provided with a plurality of layers of installing holes, installing holes in adjacent two layers are arranged in a staggered manner, and the damper member is installed at the fixing plate via the installing holes.
